(19) United States
(12) Patent Application Publication
(10) Pub. No.: US 2019/0012907 A1
(43) Pub. Date: Jan. 10, 2019

(54) DRIVING ANALYSIS DEVICE AND DRIVING BEHAVIOR ANALYSIS SYSTEM

(71) Applicant: Panasonic Intellectual Property Management Co., Ltd., Osaka (JP)

(72) Inventor: Hiroshi ITAHARA, Osaka (JP)

(21) Appl. No.: 16/131,832

(22) Filed: Sep. 14, 2018

Related U.S. Application Data
(63) Continuation of application No. PCT/JP2016/004147, filed on Sep. 12, 2016.

(30) Foreign Application Priority Data
Mar. 16, 2016 (JP) 2016-052843

(51) Int. Cl. G08G 1/01; G07C 5/08

(52) U.S. Cl. CPC G08G 1/0112; G07C 5/0816; G07C 5/0841

(57) ABSTRACT

A driving analysis device comprises: a communicator configured to acquire yaw rates of vehicles driven by drivers and vehicle speeds corresponding to the angular velocities, and accident log information on whether or not the drivers each have accident logs; and a controller configured to analyze the driving behaviors of the steering operation of the plurality of drivers on the basis of the angular velocities and the vehicle speeds, and the accident log information. The controller categorizes the angular velocities into a first group having accident logs and a second group having no accident log, and determines at least one of a first reference value for detection of the abrupt steering operation or a second reference value for detection of the unsteady steering operation in accordance with an angular velocity at a boundary between the first group and the second group, for each of various vehicle speeds.

### TECHNICAL FIELD

The present disclosure relates to a driving analysis device configured to analyze a driving behavior of driver's steering operation and determine a reference value for detection of abrupt steering operation or unsteady steering operation.

### BACKGROUND

Japanese Laid-Open Patent Publication No. 2006-243856 discloses a method and a device for driving diagnosis of diagnosing driver's safe driving. The method and the device for driving diagnosis includes and executes receiving vehicle behavior data from a car navigation system, obtaining acceleration distribution from acceleration chronological information in the behavior data, statistically processing the acceleration distribution, generating safe driving diagnostic contents (including a safe driving degree) including a result thereof as a diagnostic item, and outputting a report thereof. The method and the device for driving diagnosis further includes and executes obtaining vehicle centrifugal force distribution from abrupt steering operation information in the behavior data, and adding a statistical result of the centrifugal force distribution in the safe driving diagnostic contents as a diagnostic item.

### SUMMARY

The present disclosure provides a driving analysis device configured to analyze a driving behavior of driver's steering operation and determine a reference value for detection of abrupt steering operation or unsteady steering operation.

### Means for Solving Problem

The present disclosure provides a driving analysis device configured to analyze driving behaviors of steering operation of a plurality of drivers and determine a reference value for detection of at least one of abrupt steering operation or unsteady steering operation of each of the drivers, the driving analysis device including: a communicator configured to acquire yaw rates of a plurality of vehicles driven by the plurality of drivers and vehicle speeds corresponding to the yaw rates, and accident log information on whether or not the drivers each have one or more accident logs; and an analyzer configured to analyze the driving behaviors of the steering operation of the plurality of drivers on the basis of the yaw rates and the vehicle speeds, and the accident log information. The analyzer categorizes the yaw rates into a first group including a vehicle yaw rate of a driver having one or more accident logs and a second group including a vehicle yaw rate of a driver having no accident log, and determines at least one of a first reference value for detection of the abrupt steering operation or a second reference value for detection of the unsteady steering operation in accordance with a yaw rate at a boundary between the first group and the second group, for each of various vehicle speeds.

The driving analysis device according to the present disclosure achieves analyzing the driving behaviors of the drivers' steering operation and determining the first reference value for detection of abrupt steering operation or the second reference value for detection of unsteady steering operation.

### BRIEF DESCRIPTION OF DRAWINGS

FIG. 1 is a configuration diagram of a driving behavior analysis system according to a first embodiment;

FIG. 2 is a configuration diagram of a vehicle, an on board diagnostics module, and a terminal device according to the first embodiment;

FIG. 3 is a configuration diagram of a driving analysis device according to the first embodiment;

FIG. 4A is a view of a vehicle motion information database in the driving analysis device;

FIG. 4B is a view of an accident log information database in the driving analysis device;

FIG. 5 is a flowchart of driving behavior analysis on steering operation of a plurality of drivers, by a controller of the driving analysis device according to the first embodiment;

FIG. 6 is an explanatory graph of first statistical analysis by the controller of the driving analysis device according to the first embodiment;

FIG. 7 is an explanatory graph of second statistical analysis by the controller of the driving analysis device according to the first embodiment; and

FIG. 8 is a flowchart of detection of abrupt steering operation and unsteady steering operation possibly causing an accident, by a controller of the terminal device according to the first embodiment.

### DESCRIPTION OF EMBODIMENT

Embodiments will now be described in detail below with reference to the drawings where appropriate. There may not be provided description in too much detail. For example, an already well-known matter may not be described in detail, and a substantially identical configuration may not be described repeatedly. This prevents redundancy of the following description as well as facilitates comprehension by those skilled in the art. The inventor(s) provide the accompanying drawings and the following description for full comprehension of the present disclosure by those skilled in the art, and do not intend to limit the subject matter recited in the claims with the accompanying drawings and the following description.

### First Embodiment

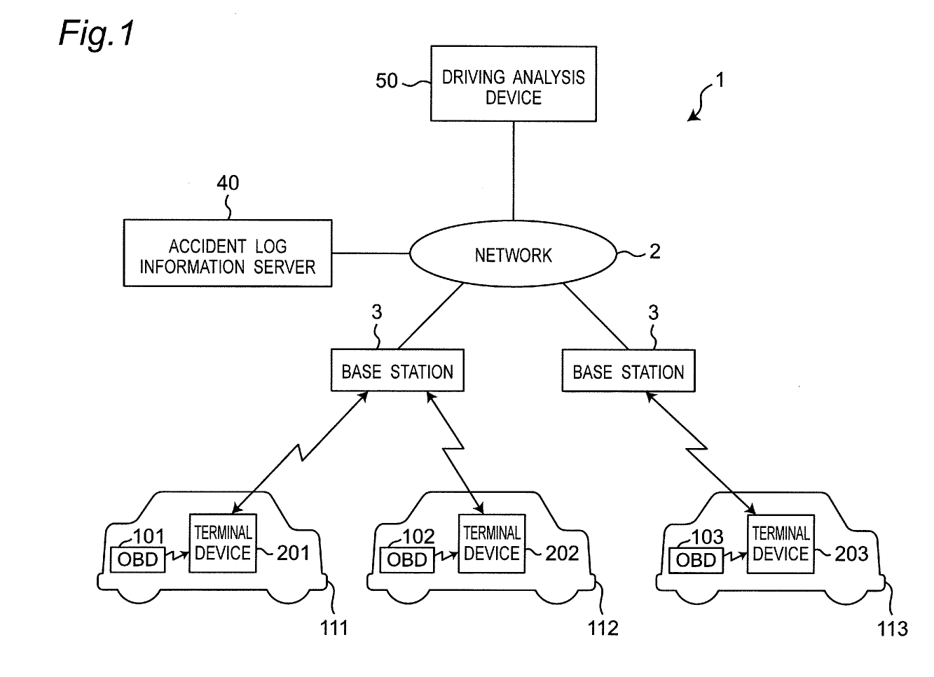

A driving behavior analysis system according to the first embodiment will be described below with reference to FIGS. 1 to 8.

### [1-1. Configuration]

### [1-1-1. Driving Behavior Analysis System]

FIG. 1 is a configuration diagram of the driving behavior analysis system according to the first embodiment. FIG. 1 depicts a driving behavior analysis system 1 configured to store, as data of steering operation of a plurality of drivers, yaw rates of a plurality of vehicles 111, 112, and 113 driven by the plurality of drivers. The driving behavior analysis system 1 statistically analyzes driving behaviors of steering operation of the plurality of drivers on the basis of the stored data, and determines a reference value (first reference value) for detection of abrupt steering operation possibly causing an accident and a reference value (second reference value) for detection of unsteady steering operation equally possibly causing an accident. The driving behavior analysis system 1 detects abrupt steering operation and unsteady steering operation, both possibly causing an accident, in the steering operation of each of the drivers, in accordance with these reference values.

The driving behavior analysis system 1 includes on board diagnostics (hereinafter, called “OBD”) modules 101, 102, and 103, terminal devices 201, 202, and 203, an accident log information server 40, and a driving analysis device 50. The terminal devices 201, 202, and 203 are each connected to a network 2 via a base station 3 which confirms to a telecommunications standard such as 3G or LTE. The terminal devices 201, 202, and 203, the accident log information server 40, and the driving analysis device 50 are configured to communicate each other via the network 2.

The present embodiment exemplifies the three vehicles 111, 112, and 113 for convenient description. However, the number of vehicles is not limited to the three. The present embodiment further exemplifies the three OBD modules 101, 102, and 103 and the three terminal devices 201, 202, and 203 corresponding to the vehicles 111, 112, and 113, respectively. However, the numbers of OBD modules and terminal devices are not limited to the three.

The OBD module 101 is installed in the vehicle 111 and transmits information on a vehicle speed of the vehicle 111 to the terminal device 201. The OBD module 101 will be described in detail later. The OBD modules 102 and 103 are configured identically to the OBD module 101 and will thus not be described herein.

The terminal device 201 is a mobile terminal device such as a smartphone or a tablet computer owned by the driver of the vehicle 111, and is mounted on the vehicle 111. The terminal device 201 includes a gyrosensor as to be described later, and detects a yaw rate of the vehicle 111. The terminal device 201 transmits, to the driving analysis device 50 via the base station 3 and the network 2, information on the detected yaw rate of the vehicle 111 and information on the vehicle speed received from the OBD module 101 at detection time thereof.

The terminal device 201 detects abrupt steering operation and unsteady steering operation, using the yaw rate of the vehicle 111, in accordance with the threshold of abrupt steering operation and the threshold of unsteady steering operation analyzed by the driving analysis device 50 to be described later. The terminal device 201 will be described in detail later. The terminal devices 202 and 203 are configured identically to the terminal device 201 and will thus not be described herein.

The accident log information server 40 manages information on whether or not the drivers each have one or more accident logs. The accident log information server 40 manages the information on whether or not the driver each have one or more accident logs, in association with information for driver identification such as names of the drivers, and transmits these information pieces to the driving analysis device 50 via the network 2 upon request.

The driving analysis device 50 stores the received information on the yaw rate and the vehicle speed of each of the vehicles 111, 112, and 113 as vehicle motion information, and the received information on whether or not the drivers each have one or more accident logs as accident log information. The driving analysis device 50 analyzes the driving behaviors of steering operation of the plurality of drivers on the basis of the stored information on the yaw rate and the vehicle speed of each of the vehicles 111, 112, and 113 and the stored information on whether or not the drivers each have one or more accident logs, and determines the threshold of abrupt steering operation possibly causing an accident and the threshold of unsteady steering operation equally possibly causing an accident. The driving analysis device 50 will be described in detail later.

### [1-1-2. OBD Module]

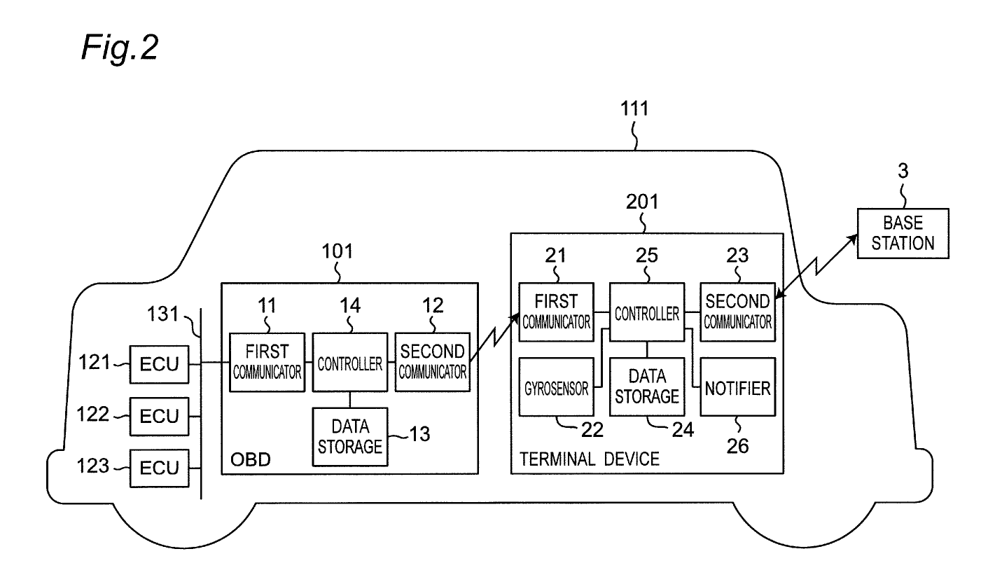

FIG. 2 is a configuration diagram of the OBD module 101 and the terminal device 201 according to the first embodiment. The OBD module 101 depicted in FIG. 2 is connected to a controller area network (hereinafter, called “CAN”) 131 connecting a plurality of electronic control units (hereinafter, called “ECU”) 121, 122, and 123 in the vehicle 111. The OBD module 101 acquires information on a vehicle speed from the ECUs 121, 122, and 123 via the CAN 131, and transmits the information on the vehicle speed to the terminal device 201. The OBD module 101 includes first and second communicators 11 and 12, a data storage 13, and a controller 14.

Each of the ECUS 121, 122, and 123 is configured to execute behavior control of either one of engine control, braking control, steering control, and the like of the vehicle. The CAN 131 is an in-vehicle network connecting the ECUs 121, 122, and 123. The ECUS 121, 122, and 123 transmit and receive each other via the CAN 131, vehicle information on a vehicle speed, vehicle acceleration, an engine rotational speed, gasoline mileage, or the like.

The first communicator 11 is a wireless communication interface which confirms to a telecommunications standard for a CAN such as ISO15765, ISO11898, or ISO11519, or a telecommunications standard for vehicle malfunction diagnosis such as ISO14230. The first communicator 11 is connected to the CAN 131 via an OBD-II terminal in the vehicle ill, and acquires information on a vehicle speed from the ECUs 121, 122, and 123 via the CAN 131.

The second communicator 12 is a wireless communication module configured to execute Nearfield wireless communication with the terminal device 201, confiLming to a telecommunications standard such as Wi-Fi or Bluetooth (registered trademark). The second communicator 12 transmits information on a vehicle speed to the teivanal device 201.

The data storage 13 is a recording medium configured by a flash memory or the like. The data storage 13 temporarily stores the information on the vehicle speed received by the first communicator 11. The data storage 13 further stores various programs for the controller 14.

The controller 14 is configured by a CPU, an MPU, or the like, and executes the various programs stored in the data storage 13 to control the entire OBD module 101. The controller 14 causes the data storage 13 to temporarily stores the vehicle information received by the first communicator 11. The controller 14 transmits the information on the vehicle speed stored in the data storage 13 to the second communicator 12.

### [1-1-3. Terminal Device]

As depicted in FIG. 2, the terminal device 201 includes first and second communicators 21 and 23, a gyrosensor 22, a data storage 24, a controller 25, and a notifier 26.

The first communicator 21 is a communication interface configured to execute Nearfield wireless communication with the OBD module 101, confirming to a telecommunications standard such as Wi-Fi or Bluetooth. The first communicator 21 receives information on a vehicle speed from the OBD module 101.

The gyrosensor 22 is incorporated in a mobile terminal device such as a smartphone or a tablet computer, and is configured to detect an angular velocity with respect to each of three axes (a yaw axis, a roll axis, and a pitch axis). The gyrosensor 22 detects a yaw rate, a roll rate, and a pitch rate of the vehicle 111.

The second communicator 23 is a communication interface configured to execute wireless communication with the base station 3, confiLming to a telecommunications standard such as 3G or LTE. The second communicator 23 transmits, to the driving analysis device 50 via the base station 3 and the network 2, information on the yaw rate of the vehicle 111 detected by the gyrosensor 22 and detection time thereof, information on a vehicle speed at the detection time, and owner information on the terminal device 201. The second communicator 23 receives, from the driving analysis device 50 via the network 2 and the base station 3, the threshold of abrupt steering operation and the threshold of unsteady steering operation.

The data storage 24 is a recording medium configured by a flash memory or the like. The data storage 24 temporarily stores the information on the yaw rate of the vehicle 111 detected by the gyrosensor 22 and the detection time thereof, and information on the vehicle speed received by the first communicator 21 and reception time thereof. The data storage 24 further stores the owner information on the terminal device 201. The data storage 24 further stores the threshold of abrupt steering operation and the threshold of unsteady steering operation, received by the second communicator 23. The data storage 24 further stores various programs for the controller 25.

The controller 25 is configured by a CPU, an MPU, or the like, and executes the various programs stored in the data storage 24 to control the entire terminal device 201. The controller 25 causes the data storage 24 to temporarily store the information on the yaw rate of the vehicle 111 detected by the gyrosensor 22 and the detection time thereof, and the information on the vehicle speed received by the first communicator 21 and the reception time thereof. The controller 25 transmits, to the second communicator 23, the information on the yaw rate of the vehicle ill and the detection time thereof and the information on the vehicle speed at the detection time, stored in the data storage 24, in association with the owner information on the terminal device 201.

The controller 25 further causes the data storage 24 to store the threshold of abrupt steering operation and the threshold of unsteady steering operation received by the second communicator 23. The controller 25 detects abrupt steering operation and unsteady steering operation, using the yaw rate of the vehicle 111 detected by the gyrosensor 22, in accordance with the threshold of abrupt steering operation and the threshold of unsteady steering operation, stored in the data storage 24.

The notifier 26 is exemplified by a sound output unit such as a speaker. The notifier 26 outputs notification sound under control by the controller 25. Other examples of the notifier 26 include an optical output unit such as an LED configured to output light, a display unit such as a display configured to display letters, images, or the like, a vibration generator such as a vibrator configured to vibrate a seat, and a seatbelt device configured to vary fastening force of a seatbelt.

### [1-1-4. Driving Analysis Device]

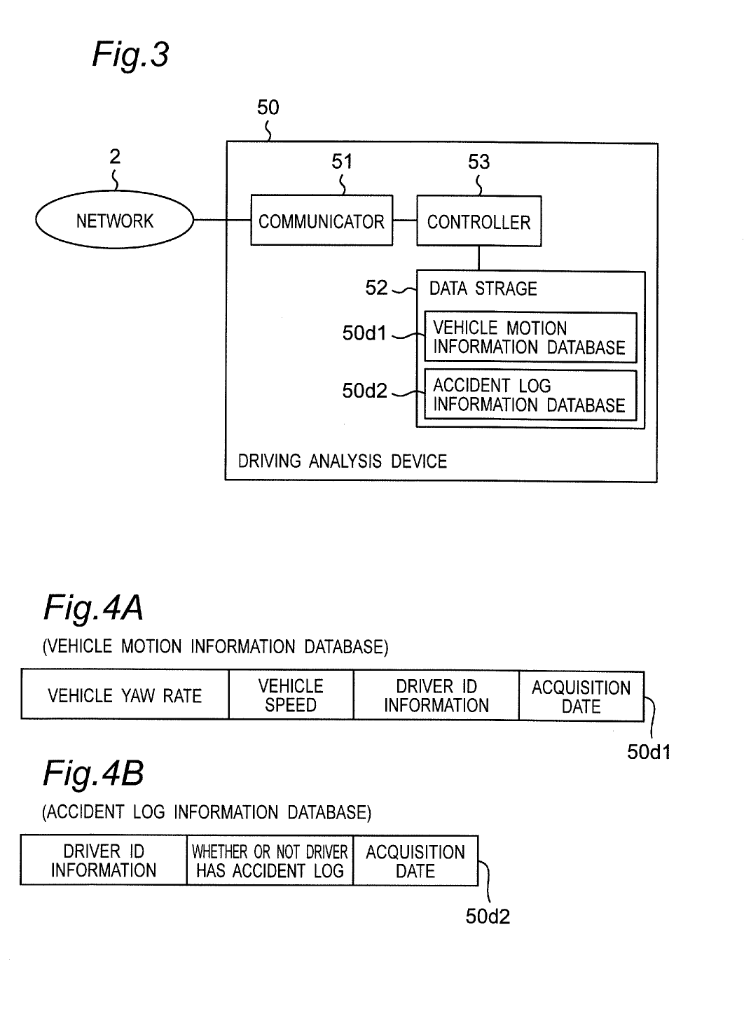

FIG. 3 is a configuration diagram of the driving analysis device 50 according to the first embodiment. The driving analysis device 50 is configured by a computer or the like. The driving analysis device 50 includes a communicator 51, a data storage 52, and a controller (analyzer) 53.

The communicator 51 is a communication interface which confirms to a telecommunications standard such as IEEE802. The communicator 51 connects the controller 53 to the network 2.

The data storage 52 is a recording medium configured by an HDD, an SSD, or the like. The data storage 52 stores a vehicle motion information database 50d1 and an accident log information database 50d2 As depicted in FIG. 4A, the vehicle motion information database 50d1 manages the yaw rates of the plurality of vehicles 111, 112, and 113, the vehicle speeds upon detection of the yaw rates, driver ID information corresponding to the owner information on the terminal device 201, and acquisition dates thereof (e.g. detection time of the yaw rates), which are in association with one another. As depicted in FIG. 4B, the accident log information database 50d2 manages the driver ID information corresponding to driver information, whether or not the drivers each have one or more accident logs, acquisition dates thereof, which are in association with one another.

The data storage 52 stores an equation (1) to be described later as an equation for calculation of the threshold of abrupt steering operation, and an equation (2) to be described later as an equation for calculation of the threshold of unsteady steering operation. The data storage 52 stores various programs for the controller 53.

The controller 53 is configured by a CPU, an MPU, or the like, and executes the various programs stored in the data storage 52 to control the entire driving analysis device 50. The controller 53 updates the vehicle motion information database 50d1 and the accident log information database 50d2.

The programs executed by the controller 25 of the terminal device 201 and the controller 53 of the driving analysis device 50 might be supplied via the network 2 or might be supplied from a recording medium such as a CD-ROM. Each of the controller 25 of the terminal device 201, the controller 53 of the driving analysis device 50, and the controller 14 of the OBD module 101 might be embodied only by hardware circuitry (e.g. an ASIC or an FPGA) such as an exclusively designed electronic circuit or a reconstructible electronic circuit.

### [1-2. Behavior]

The driving behavior analysis system 1 configured as described above will be described in terms of its behavior. Behavior of the vehicle 111, the OBD module 101, and the terminal device 201 will be described below out of the vehicles 111, 112, and 113, the OBD modules 101, 102, and 103, and the terminal devices 201, 202, and 203. The vehicles 112 and 113, the OBD modules 102 and 103, and the terminal devices 202 and 203 behave similarly.

When the driver sets the terminal device 201 in the vehicle 111 and starts the engine of the vehicle 111, the OBD module 101 transmits information on a vehicle speed of the vehicle 111 to the terminal device 201 repetitively at a predetermined time interval. The terminal device 201 stores, in the data storage 24, information on a yaw rate of the vehicle 111 detected by the gyrosensor 22 and detection time thereof, information on a vehicle speed received from the OBD module 101 at the detection time, and the owner information on the teminal device 201. The terminal device 201 transmits the stored information to the driving analysis device 50 via the base station 3 and the network 2 in response to user operation. The terminal device 201 might alternatively transmit the stored information at a predetermined time interval.

The driving analysis device 50 stores, in the vehicle motion information database 50d1 depicted in FIG. 4A, yaw rates of the vehicles 111, 112, and 113, vehicle speeds upon detection of the yaw rates, driver ID information corresponding to owner information on the terminal devices 201, 202, and 203, and acquisition dates thereof (e.g. detection time of the yaw rates), which are in association with one another.

The accident log information server 40 transmits information on whether or not the drivers each have one or more accident logs in association with information on the drivers, to the driving analysis device 50 via the network 2, upon request from the driving analysis device 50. The driving analysis device 50 stores, in the accident log information database 50d2 depicted in FIG. 4B, the driver ID information corresponding to the driver information, whether or not the drivers each have one or more accident logs, and acquisition dates thereof, which are in association with one another.

### [1-2-1. Driving Behavior Analysis on Steering Operation]

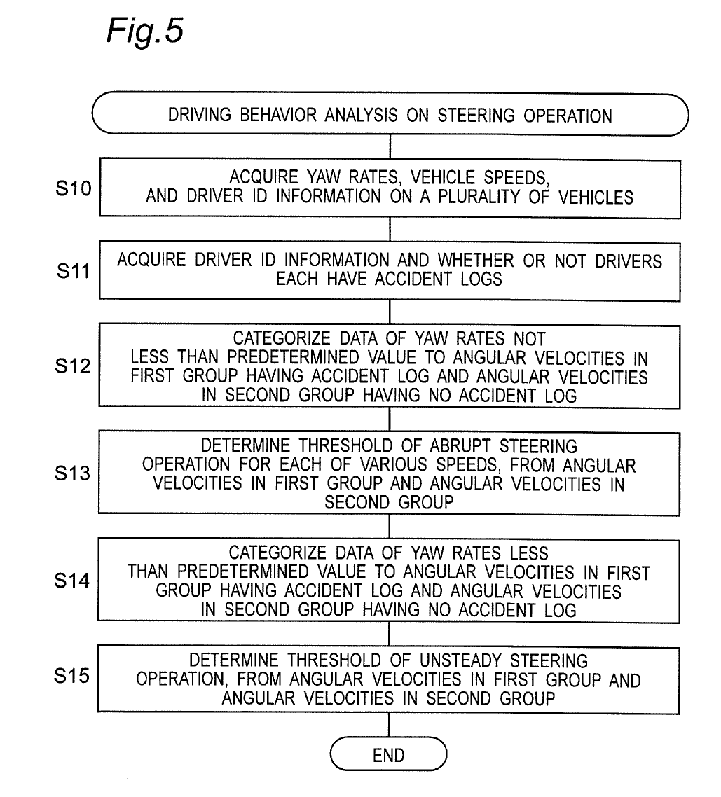

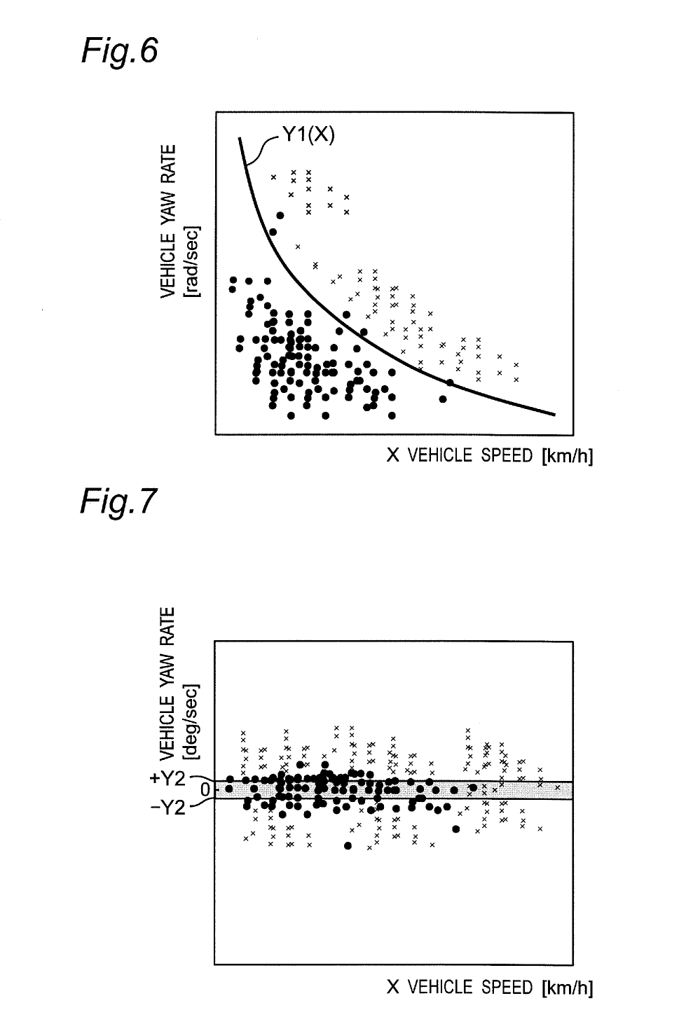

Driving behavior analysis on steering operation of the plurality of drivers by the controller 53 of the driving analysis device 50 according to the present first embodiment will be described below with reference to the flowchart in FIG. 5 and the explanatory yLaphs of statistical analysis in FIGS. 6 and 7.

The controller 53 of the driving analysis device 50 executes first statistical analysis for obtainment of the threshold of abrupt steering operation and second statistical analysis for obtainment of the threshold of unsteady steering operation, on the basis of the information in the vehicle motion information database 50d1 and the information in the accident log information database 50d2.

The inventor(s) of the present application have found that driver's steering operation and a vehicle yaw rate have the following correlation. A vehicle yaw rate corresponding to driver's unconsciousness steering (unsteady steering operation) during travel on a straight road has a relatively small value, whereas a vehicle yaw rate corresponding to driver's intended steering for curving at an intersection, a curved line, or the like of a road has a relatively large value.

In view of this, the present embodiment includes setting an angular velocity boundary (predetermined value) for distinction between a distribution range of vehicle yaw rates corresponding to drivers' unconsciousness unsteady steering operation and a distribution range of vehicle yaw rates corresponding to drivers' intended steering. The present embodiment further includes executing the first statistical analysis based on yaw rates not less than the predetermined value at the boundary to obtain the threshold of abrupt steering operation possibly causing an accident. The present embodiment also includes executing the second statistical analysis based on yaw rates less than the predetermined value to obtain the threshold of unsteady steering operation possibly causing an accident.

With reference to the flowchart in FIG. 5, the controller 53 acquires, from the vehicle motion information database 50d1, the yaw rates, the vehicle speeds, and the driver ID information on the plurality of vehicles 111, 112, and 113 (S10). The controller 53 also acquires, from the accident log information database 50d2, the driver ID information and whether or not the drivers each have one or more accident logs (S11).

The controller 53 subsequently executes the first statistical analysis based on the acquired various types of data. FIG. 6 is an explanatory yLaph of the first statistical analysis executed by the controller 53. FIG. 6 indicates a correlation between the vehicle yaw rates and the vehicle speeds plotting the data acquired from the plurality of vehicles. FIG. 6 particularly plots data of the yaw rates not less than the predetermined value for obtainment of the threshold of abrupt steering operation.

As indicated in FIG. 6, the controller 53 categorizes, in the first statistical analysis, data of the yaw rates not less than the predetermined value, to angular velocities in a first group (indicated by symbols x in FIG. 6) corresponding to driver ID information on drivers having one or more accident logs and angular velocities in a second group (indicated by black circles in FIG. 6) corresponding to driver ID information on drivers having no accident log (S12).

The controller 53 subsequently determines the following equation (1) for calculation of a threshold Y1(X) of abrupt steering operation possibly causing an accident for each of various speeds, from the angular velocities in the first group and the angular velocities in the second group (S13).

Y1 (X)=π400/(180X) [rad/sec] (1)

In this equation, X indicates a vehicle speed.

Specifically, the controller 53 obtains a boundary between the angular velocities in the first group and the angular velocities in the second group. The controller 53 then sets an angular velocity at the boundary as the threshold of abrupt steering operation. For example, the controller 53 determines the angular velocity at the boundary to be out of a 95% reliability limit of the first group (a standard deviation of ±1.96σ) as well as out of a 95% reliability limit of the second group (a standard deviation of ±1.96σ).

The controller 53 according to the present embodiment approximates the angular velocity at the boundary between the first group and the second group obtained for each of various speeds, in accordance with a linear approximate formula, to approximate the threshold of abrupt steering operation for each of various speeds as indicated by a solid line Y1(X) in FIG. 6 so as to obtain the equation (1).

As indicated in FIG. 6, the vehicle yaw rates corresponding to drivers' intended steering for curving at an intersection, a curved line, or the like of a road are distributed dependently on the vehicle speeds and are distributed in a smaller range at higher vehicle speeds, to be in inverse proportion to the vehicle speeds. The threshold Y1(X) of abrupt steering operation is thus expressed by an approximate formula of inverse proportion to the vehicle speeds as indicated by the solid line in FIG. 6 and as expressed by the equation (1).

The threshold Y1(X) (threshold function) is provided for a maximum value in a certain period (e.g. one second) of observed values of vehicle yaw rates (angular velocities of steering wheel). The maximum observed value not less than the threshold Y1(X) is determined as indicating abrupt steering operation, whereas the maximum observed value less than the threshold Y1(X) is determined as not indicating abrupt steering operation.

The controller 53 subsequently executes the second statistical analysis based on the various types of data acquired in steps S10 and S11. FIG. 7 is an explanatory graph of the second statistical analysis executed by the controller 53. FIG. 7 indicates a correlation between the vehicle yaw rates and the vehicle speeds plotting the data acquired from the plurality of vehicles. FIG. 7 particularly plots data of the yaw rates less than the predetermined value for obtainment of the threshold of unsteady steering operation.

As indicated in FIG. 7, the controller 53 categorizes, in the second statistical analysis, data of the yaw rates less than the predetermined value, to angular velocities in a first group (indicated by symbols x in FIG. 7) corresponding to driver ID information on drivers having one or more accident logs and angular velocities in a second group (indicated by black circles in FIG. 7) corresponding to driver ID information on drivers having no accident log (S14).

The controller 53 subsequently determines the following equation (2) for calculation of a threshold Y2 of unsteady steering operation possibly causing an accident, from the angular velocities in the first group and the angular velocities in the second group (S15).

Y2=±3 [deg/sec] (2)

Specifically, the controller 53 obtains a boundary between the angular velocities in the first group and the angular velocities in the second group. The controller 53 then detemines an angular velocity at the boundary as the threshold of unsteady steering operation as indicated by a solid line Y2 in FIG. 7 to obtain the equation (2). For example, the controller 53 determines the angular velocity at the boundary to be out of a 95% reliability limit of the first group (a standard deviation of ±1.96σ) as well as out of a 95% reliability limit of the second group (a standard deviation of ±1.96σ). In the present embodiment, as indicated in FIG. 7, the threshold Y2 of unsteady steering operation corresponds to the standard deviation of the angular velocity distribution in the second ytoup having an average value 0 deg/sec.

As indicated in FIG. 7, the vehicle yaw rates corresponding to drivers' unconsciousness unsteady steering operation during travel on straight roads are distributed independently from the vehicle speeds. The threshold Y2 of unsteady steering operation is thus indicated by a constant value, as indicated by the solid line in FIG. 7 and as expressed by the equation (2).

The threshold Y2 is provided for the observed values of the vehicle yaw rates (angular velocities of steering wheel). The observed value not less than the threshold Y2 is determined as indicating unsteady steering operation (variation in angular velocity of steering wheel), whereas the observed value less than the threshold Y2 is determined as not indicating unsteady steering operation (variation in angular velocity of steering wheel).

### [1-2-2. Detection of Abrupt Steering Operation and Unsteady Steering Operation]

Each of the terminal devices 201, 202, and 203 according to the present embodiment is configured to detect abrupt steering operation and unsteady steering operation, both possibly causing an accident, in accordance with the equation (1) for calculation of the threshold Y1(X) of abrupt steering operation and the equation (2) for calculation of the threshold Y2 of unsteady steering operation, which are obtained by the driving analysis device 50.

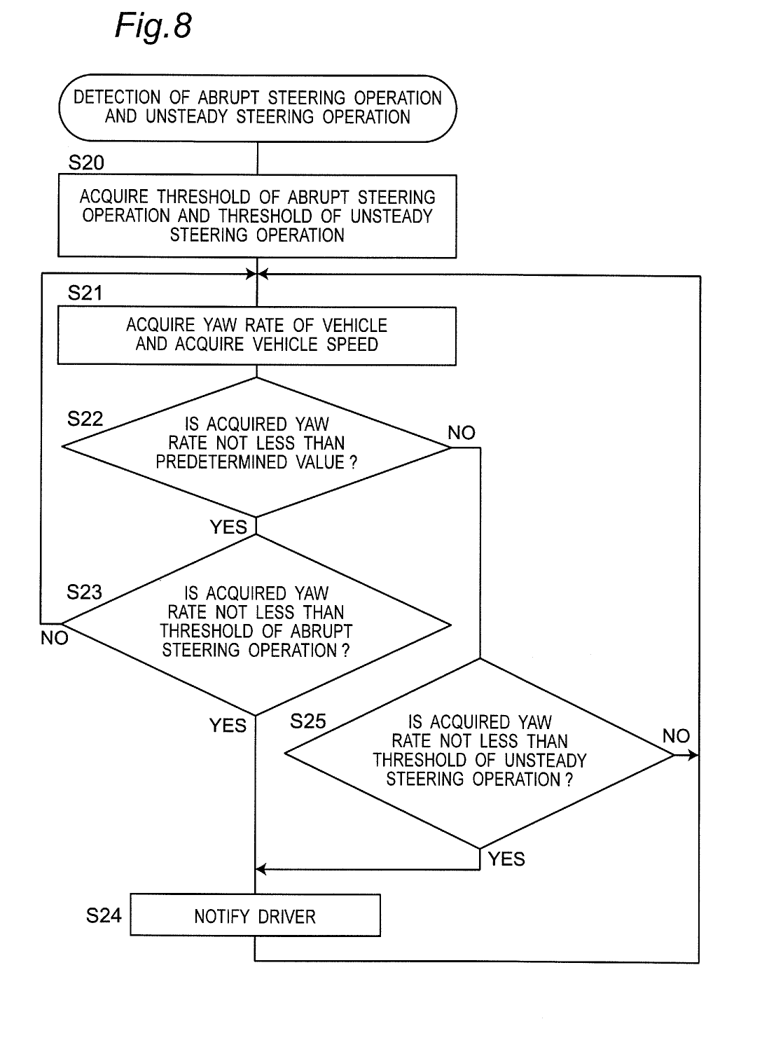

Described below with reference to the flowchart in FIG. 8 is detection of abrupt steering operation and unsteady steering operation, each possibly causing an accident, by the controller 25 of the terminal device 201 according to the first embodiment.

Each of the te minal devices 201, 202, and 203 receives, from the driving analysis device 50, information on the equation (1) for calculation of the threshold Y1(X) of abrupt steering operation and information on the equation (2) for calculation of the threshold Y2 of unsteady steering operation, and stores these pieces of information in the data storage 24. The controller 25 of the terminal device 201 will be described below in terms of its behavior. The controller of the terminal device 202 and the controller of the terminal device 203 behave similarly.

The controller 25 acquires, from the data storage 24, the information on the equation (1) for calculation of the threshold Y1(X) of abrupt steering operation and the information on the equation (2) for calculation of the threshold Y2 of unsteady steering operation (S20). The controller 25 also acquires information on a yaw rate of the vehicle 111 from the gyrosensor 22 and acquires information on a vehicle speed from the OBD module 101 via the first communicator 21 (S21).

The controller 25 subsequently determines whether or not the acquired yaw rate is not less than the predetermined value (S22). If the acquired yaw rate is not less than the predetermined value, driver's current steering operation is regarded as being intended by the driver for curving at an intersection, a curved line, or the like of a road. Thus, in this case, the controller 25 determines whether or not the current steering operation is sudden. Specifically, the controller 25 obtains the threshold Y1(X) of abrupt steering operation from a vehicle speed X corresponding to the acquired yaw rate (the maximum value in a certain period such as one second) in accordance with the equation (1), and determines whether or not the acquired yaw rate (the maximum value in a certain period such as one second) is not less than the threshold Y1(X) of abrupt steering operation (S23).

In a case where the acquired yaw rate (the maximum value in a certain period such as one second) is not less than the threshold Y1(X) of abrupt steering operation, driver's current steering operation is regarded as being abrupt steering operation possibly causing an accident. Thus, in this case, the controller 25 controls the notifier 26 for output of notification sound (S24). This urges the driver to drive safely. The process flow of the controller 25 then returns to step S21 and the controller 25 repeats the processing described above.

In another case where the acquired yaw rate (the maximum value in a certain period such as one second) is less than the threshold Y1(X) of abrupt steering operation, driver's current steering operation is regarded as being safe. Thus, in this case, the process flow of the controller 25 returns to step S21 and the controller 25 repeats the processing described above.

If the acquired yaw rate is less than the predetermined value in step S22 (NO at S22), driver's current steering operation is regarded as being unconsciousness unsteady steering operation during travel on a straight road. Thus, in this case, the controller 25 determines whether or not the current steering operation is unsteady. Specifically, the controller 25 deteuttines, regardless of the vehicle speed, whether or not an absolute value of the acquired yaw rate is not less than an absolute value of the threshold Y2 of unsteady steering operation calculated in accordance with the equation (2) (S25).

In a case where the absolute value of the acquired yaw rate is not less than the absolute value of the threshold Y2 of unsteady steering operation, driver's current steering operation is regarded as being unsteady steering operation possibly causing an accident. Thus, in this case, the controller 25 controls the notifier 26 for output of notification sound (S24). This urges the driver to drive safely. The process flow of the controller 25 then returns to step S21 and the controller 25 repeats the processing described above.

In another case where the absolute value of the acquired yaw rate is less than the absolute value of the threshold Y2 of unsteady steering operation, driver's current steering operation is regarded as being safe. Thus, in this case, the process flow of the controller 25 returns to step S21 and the controller 25 repeats the processing described above.

### [1-3. Effects]

As described above, the driving analysis device 50 according to the present embodiment is configured to analyze driving behaviors of steering operation of a plurality of drivers and determine reference values for detection of abrupt steering operation and unsteady steering operation of each of the drivers, and includes the communicator 51 and the controller 53. The communicator 51 acquires yaw rates of the plurality of vehicles 111, 112, and 113 driven by the plurality of drivers, vehicle speeds corresponding to the yaw rates, and accident log information on whether or not the plurality of drivers has one or more accident logs. The controller 53 analyzes the driving behaviors of steering operation of the plurality of drivers on the basis of the yaw rates and the vehicle speeds, and the accident log information. The controller 53 categorizes the yaw rates into the first group including vehicle yaw rates of drivers having one or more accident logs and the second group including vehicle yaw rates of drivers having no accident log, and determines the reference value for detection of abrupt steering operation and the reference value for detection of unsteady steering operation for each of various speeds, in accordance with the yaw rate at the boundary between the first group and the second group.

This achieves obtainment of the threshold of abrupt steering operation possibly causing an accident and the threshold of unsteady steering operation equally possibly causing an accident, according to the vehicle yaw rate at the boundary between data of drivers having one or more actual accident logs and data of drivers having no accident log. Application of these thresholds thus enables highly accurate detection of abrupt steering operation and unsteady steering operation, both possibly causing an accident.

Recent improvement in vehicle control technology and tire performance causes change in amount of abrupt steering operation and unsteady steering operation causing an accident. In view of this, the present embodiment includes obtaining the thresholds of abrupt steering operation and unsteady steering operation not in accordance with the amount of steering operation (a steering angle of the steering wheel) but in accordance with the yaw rate of the vehicle developed with the improved vehicle control technology and the improved tire performance. These thresholds are commonly applicable to various vehicles independently from the vehicle control technology and the tire performance. Detection of abrupt steering operation and unsteady steering operation using the yaw rate of the vehicle according to these thresholds achieves highly accurate detection of abrupt steering operation and unsteady steering operation of various vehicles.

### Other Embodiments

The first embodiment is described above to exemplify the technique disclosed in the present application. The technique according to the present disclosure is not limited to the above, but is also applicable to embodiments achieved through appropriate modification, replacement, addition, exclusion, and the like. Other embodiments will be exemplified below.

The first embodiment exemplifies the driving analysis device 50 configured to execute statistical analysis of categorizing the yaw rates of the plurality of vehicles 111, 112, and 113 into the two groups on the basis of the drivers' accident log information, to determine the threshold of abrupt steering operation possibly causing an accident and the threshold of unsteady steering operation equally possibly causing an accident. The idea of the present disclosure is not limited to the above, but is also applicable to an aspect of executing statistical analysis of categorizing the yaw rates of the plurality of vehicles 111, 112, and 113 into further segmentalized groups according to driver properties such as ages and genders, vehicle properties such as vehicle types, attributes such as seasons and ambient temperatures (road freeze information), and the like, and determining a threshold of abrupt steering operation and a threshold of unsteady steering operation.

The first embodiment adopts the linear approximate formula including a variable vehicle speed as in the equation (1) for calculation of the threshold of abrupt steering operation, and the constant value as in the equation (2) for calculation of the threshold of unsteady steering operation. The idea of the present disclosure is not limited to the above. Alternatively, an n-th approximate formula (n is an integer not less than one) including a variable vehicle speed or the like is applicable as an equation for calculation of the threshold of abrupt steering operation and an equation for calculation of the threshold of unsteady steering operation.

The first embodiment exemplifies the driving behavior analysis system 1 configured to download, to the terminal devices 201, 202, and 203, the threshold of abrupt steering operation and the threshold of unsteady steering operation analyzed by the driving analysis device 50, and cause the terminal devices 201, 202, and 203 to detect abrupt steering operation and unsteady steering operation. The idea of the present disclosure is not limited to the above, but is also applicable to an aspect of causing the driving analysis device 50 to detect abrupt steering operation and unsteady steering operation and notify the terminal devices 201, 202, and 203 of a detection result.

The idea of the present disclosure is also applicable to an aspect of causing the OBD modules 101, 102, and 103 or the vehicles 111, 112, and 113 to detect abrupt steering operation and unsteady steering operation.

The first embodiment includes obtaining vehicle yaw rates with use of the gyrosensors built in the terminal devices 201, 202, and 203. The present disclosure is not limited to the above, but might alternatively include obtaining vehicle yaw rates with use of gyrosensors installed in the vehicles 111, 112, and 113 or the OBD modules 101, 102, and 103.

The first embodiment includes causing the notifier 26 to notify a driver upon detection of abrupt steering operation and unsteady steering operation. The present disclosure is not limited to the above, but might alternatively include counting the number of times of detection of abrupt steering operation and unsteady steering operation, and notifying a driver at predetermined timing (e.g. at a predetermined time interval or upon applying the parking breaking), by means of sound information, visual information, or the like, a ratio of abrupt steering operation possibly causing an accident to entire steering operation, a ratio of unsteady steering operation possibly causing an accident to entire unsteady steering operation, and the like.

The first embodiment includes obtaining the thresholds of both abrupt steering operation and unsteady steering operation, and detecting both abrupt steering operation and unsteady steering operation in accordance with these thresholds. The present disclosure is not limited to the above, but might alternatively include obtaining the threshold of either one of abrupt steering operation and unsteady steering operation, and detecting the either one of abrupt steering operation and unsteady steering operation in accordance with the threshold.

The embodiments are described above to exemplify the technique according to the present disclosure. The accompanying drawings and the detailed description have been provided for this purpose. The constituent elements referred to in the accompanying drawing and the detailed description might thus include, essential constituent elements for achievement of the purpose as well as unessential constituent elements for achievement of the purpose. Such unessential constituent elements should not be regarded as being essential simply because the accompanying drawings and the detailed description refer to the unessential constituent elements. The above embodiments are described to exemplify the technique according to the present disclosure, and might thus be changed by various modification, replacement, addition, exclusion, and the like within the scope of the claims or an equivalent scope.

### INDUSTRIAL APPLICABILITY

The present disclosure is applicable to the driving analysis device configured to analyze driving behaviors of steering operation of a plurality of drivers and determine a reference value for detection of abrupt steering operation or unsteady steering operation of each of the drivers.

1. A driving analysis device configured to analyze driving behaviors of steering operation of a plurality of drivers and determine a reference value for detection of at least one of abrupt steering operation or unsteady steering operation of each of the drivers, the driving analysis device comprising:
an analysis communicator configured to acquire yaw rates of a plurality of vehicles driven by the plurality of drivers and vehicle speeds corresponding to the yaw rates, and accident log information on whether or not the drivers each have one or more accident logs; and
an analyzer configured to analyze the driving behaviors of the steering operation of the plurality of drivers on the basis of the yaw rates and the vehicle speeds, and the accident log information,
wherein
the analyzer categorizes the yaw rates into a first group including a vehicle yaw rate of a driver having one or more accident logs and a second group including a vehicle yaw rate of a driver having no accident log, and determines at least one of a first reference value for detection of the abrupt steering operation or a second reference value for detection of the unsteady steering operation in accordance with a yaw rate at a boundary between the first group and the second group, for each of various vehicle speeds.

2. The driving analysis device according to claim 1, wherein
the analyzer determines a yaw rate out of a reliability limit of the first group and out of a reliability limit of the second group, as the yaw rate at the boundary between the first group and the second group.

3. The driving analysis device according to claim 1, wherein
the analyzer
categorizes yaw rates not less than a predetermined value out of the yaw rates, into the first group and the second group, and
determines, as the first reference value, the yaw rate at the boundary between the first group and the second group, for each of various vehicle speeds.

4. The driving analysis device according to claim 3, wherein
the first reference value is expressed by an n-th approximate formula including a variable vehicle speed.

5. The driving analysis device according to claim 4, wherein
the first reference value Y1(X) is expressed by an equation (1),
Y1(X)=π400/(180X) [rad/sec] (1)
in which X is a vehicle speed.

6. The driving analysis device according to claim 1, wherein
the analyzer
categorizes yaw rates less than a predetermined value out of the yaw rates, into the first group and the second group, and
determines, as the second reference value, the yaw rate at the boundary between the first group and the second group, for each of various vehicle speeds.

7. The driving analysis device according to claim 6, wherein
the second reference value Y2 is expressed by an equation (2).
Y2=±3 [deg/sec] (2)

8. A driving behavior analysis system configured to analyze driving behaviors of steering operation of a plurality of drivers and determine a reference value for detection of at least one of abrupt steering operation or unsteady steering operation of each of the drivers, the driving behavior analysis system comprising:
a plurality of terminal devices owned by the plurality of drivers and configured to transmit, to the driving analysis device according to claim 1, yaw rates of a plurality of vehicles driven by the plurality of drivers and vehicle speeds corresponding to the yaw rates, in association with owner information on the terminal devices; and
the driving analysis device configured to analyze the driving behaviors of the steering operation of the plurality of drivers on the basis of the yaw rates and the vehicle speeds, and accident log information on the drivers corresponding to the owner information, and determine at least one of a first reference value for detection of abrupt steering operation or a second reference value for detection of unsteady steering operation.

9. The driving behavior analysis system according to claim 8, wherein
each of the terminal devices is mounted on a corresponding one of the vehicles, and
each of the terminal devices includes
a first terminal communicator configured to acquire information on the vehicle speed of the vehicle mounted with the corresponding terminal device,
a gyrosensor configured to detect the yaw rate of the vehicle mounted with the corresponding terminal device, and
a second terminal communicator configured to transmit, to the driving analysis device, information on the yaw rate and information on the vehicle speed.

10. The driving behavior analysis system according to claim 9, wherein
the second terminal communicator receives at least one of the first reference value or the second reference value from the driving analysis device, and
each of the terminal devices includes a detector configured to detect at least one of the abrupt steering operation or the unsteady steering operation, using the yaw rate acquired by the first terminal communicator, in accordance with at least one of the first reference value or the second reference value.

11. The driving behavior analysis system according to claim 8, wherein
each of the terminal devices includes a notifier configured to notify a corresponding one of the drivers when the detector detects at least one of the abrupt steering operation or the unsteady steering operation.
